(19) United States
(12) Patent Application Publication
(10) Pub. No.: US 2019/0347027 A1
(43) Pub. Date: Nov. 14, 2019

(54) PINNING IN A MULTI-TIERED SYSTEM

(71) Applicant: Microsoft Technology Licensing, LLC, Redmond, WA (US)

(72) Inventors: Karan MEHRA, Sammamish, WA (US); Neal Robert CHRISTIANSEN, Bellevue, WA (US); Andrew HERRON, Anacortes, WA (US)

(21) Appl. No.: 15/979,371

(22) Filed: May 14, 2018

(51) Int. Cl. G06F 3/06

(52) U.S. Cl. CPC G06F 3/0643; G06F 3/0631; G06F 3/0611; G06F 3/0644; G06F 3/0685

(57) ABSTRACT

A computing device has a tiered storage with at least two types of storage classes which further comprise storage tiers. A file system is instantiated that is configured to allocate storage implemented as a plurality of storage classes, the storage classes each corresponding to a set of storage tiers having performance and capacity characteristics. A content item is pinned with a first one of the storage classes. Storage in a storage tier is allocated to the content item in accordance with the pinned first storage class.

### BACKGROUND

Computing systems typically utilize various types of non-volatile data storage. For example, a computer system may have multiple storage devices, such as one or more hard drives, solid state drives, etc. When multiple storage devices are used, they can be arranged in various ways to provide certain levels of performance and capacity. For example, physical disk drive components may be combined into one or more logical units, and data may be distributed across the drives depending on the desired level of redundancy, performance, reliability, availability, and capacity.

Computing systems may also use storage hierarchies when storing applications and other files. One level of a local storage hierarchy might be a disk, such as a mechanical disk, optical disk and the like. Additional levels of a storage hierarchy might include devices such as solid-state disks or non-volatile memory and the like.

Computing systems may be configured to operate most efficiently by locating higher demand blocks of data in storage that provide faster read responses, while lesser demanded blocks of data may be located in storage that provides capacity and less in terms of read performance.

It is with respect to these and other considerations that the disclosure made herein is presented.

### SUMMARY

In various embodiments described herein, methods and systems are disclosed for pinning various content items to a particular class of storage. In some embodiments, a number of storage classes may be defined in a storage system, each of which have a characteristic performance and capacity that may be implemented using a storage tier or a combination of storage tiers. Each storage tier may be implemented as a particular storage device type such as a solid state drive (SSD). By implementing each storage class with one or more tiers, a level of performance and capacity may be defined for each storage class, which may be implemented with storage tiers to provide the specified level of performance and capacity while abstracting the specific storage tiers that underlie the storage class. This is advantageous because the specific details of the storage tiers may change (for example, storage hardware may be replaced in a computing device) and a requesting process or user need not be concerned with such details.

In some embodiments, a storage class with faster I/O performance may be referred to as a performance class, and may be implemented primarily with faster response storage tiers such as an SSD. In one embodiment, storage with higher storage capacity but with slower random access speeds may be referred to as a capacity class, and may be implemented primarily with higher storage capacity tiers such as a rotational drive.

The present disclosure provides a way to more predictably obtain efficient I/O performance when using a tiered storage system by pinning components that are known to be consistently and deterministically accessed by known processes. Pinning may, in some examples, refer to indicating, for a given component, a storage class of a multi-tiered storage system. Pinning may be implemented via a setting in metadata associated with the component, via settings in a file allocation table, or any other means for associating the desired pinning with a component. In an embodiment, when a component is pinned to a class, one or more memory blocks in the physical address space of a tier in the pinned class may be allocated for the component.

The efficiencies of consistently providing fastest data access to what is deterministically known to be accessed, or has a specified likelihood of being accessed, can allow for improved efficiency and performance when executing boot and other processes that require access to stored data. A determination as to which of the classes to pin a particular component may be based on a deterministic assessment of the demand for a component. For example, during a boot sequence, the directories and system files that are known to be accessed based on historical data may be identified as candidates for pinning to a particular class. It should be noted that in some embodiments, requests can be made to pin a component to a particular tier. However, in the examples further described herein, requests are for pinning a component to a particular class.

In one example, a computing system may have a set of components that may be used for system launch such as system binaries and drivers that are determined to be consistently accessed by the boot loader as part of the boot process. For such folders and files that are consistently accessed on the boot path, it would be advantageous to pin these folders and files to a performance class in order to have the components loaded with a quick response time. Additionally, other directories and files that are deterministically identified as being consistently accessed may be pinned to the performance class to ensure faster boot performance.

An additional advantage of using a pinning mechanism is that some files or directories may have portions of the files or directories that can benefit from being allocated to one tier or class, but other portions of the files or directories that do not require the same type of tier or class. For example, some portions of the files or directories may be identified as requiring a performance tier or class, and other portions may be identified as only requiring a capacity tier or class. In some embodiments, portions of files, or subfiles, may be allocated to different tiers or classes. In some embodiments, an allocation mechanism may be provided that allows specific files or portions of files to be pinned or allocated to a selected tier. For example, some parts of a file may have different usage profiles, as some parts may have high usage and other parts may be rarely accessed. In one embodiment, cluster-level granularity may be provided for pinning to tiers or classes. For example, a range of clusters may be pinned to a designated class or tier, where the range may be a subset of a file or other component.

The decision as to which components are to be pinned to each tier may be determined by the OEM or other entity based on known and deterministic information, such as information regarding the loading profile of an operating system or other function. In some embodiments, the pinning of a content item, once established, may not be modifiable. An operating system typically has many files, executables, DLLs, drivers, hives, event log files, scripts, data files, settings, and the like. It may be determined that a subset of these components, such as the executables, DLLs, and drivers, are consistently and frequently accessed and therefore would benefit from being pinned to the performance class. This determination may be based on actual observed data that demonstrate a known usage profile for the components. For example, boot profiles may be deterministic for a given set of computing resources. The system provider may analyze boot profiles and monitor data for which components are accessed over time. Based on analysis of the profiles over a number of boot cycles, a determination can be made regarding which components are most frequently accessed, or some other desired profile. Based on this analysis, various components can be pinned to the performance class, for example. By selecting components that are known to be accessed in a deterministic and predictable manner, the speed and efficiency of various functions such as launching the operating system and launching applications can be improved.

This Summary is provided to introduce a selection of concepts in a simplified form that are further described below in the Detailed Description. This Summary is not intended to identify key or essential features of the claimed subject matter, nor is it intended to be used as an aid in determining the scope of the claimed subject matter. The term “techniques,” for instance, may refer to system(s), method(s), computer-readable instructions, module(s), algorithms, hardware logic, and/or operation(s) as permitted by the context described above and throughout the document.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items. References made to individual items of a plurality of items can use a reference number with a letter or a sequence of letters to refer to each individual item. Generic references to the items may use the specific reference number without the sequence of letters.

FIG. 1 an example computer architecture for a computer capable of implementing a storage allocation system as described herein.

FIG. 2 illustrates an example of storage allocation in one embodiment.

FIG. 3 illustrates an example of storage allocation in one embodiment.

FIG. 4 illustrates an example of storage allocation in one embodiment.

FIG. 5 illustrates an example data structure in accordance with the present disclosure.

FIG. 6 is a flow diagram of an illustrative process for storage allocation in accordance with the present disclosure.

FIG. 7 is a flow diagram of an illustrative process for storage allocation in accordance with the present disclosure.

FIG. 8 is a flow diagram of an illustrative process for storage allocation in accordance with the present disclosure.

### DETAILED DESCRIPTION

A computing system may implement multiple storage hierarchies or classes, and may further provide a virtualized storage system that hides or abstracts the details of the multiple storage classes. The storage classes may each comprise one or more storage tiers that are implemented with specific storage devices. For example, the file system may view the virtualized storage in the form of a volume without visibility into the storage hierarchy. The volume may be a single logical namespace visible to the file system. The volume may be provisioned to be a specified size and may correspond to the boundaries of one or more underlying storage devices. For instance, a disk may be a single volume, or perhaps be partitioned into multiple volumes. Furthermore, a volume may be made of multiple disks. The file system may then structure directories within the volume, and save files into the namespace, either at the root directory of the namespace, or within one of the directories of the namespaces.

In various embodiments described herein, methods and systems are disclosed for pinning various content items to a particular class or type of storage of storage system with multiple tiers or hierarchies. A content item may be a software component, file, executable, and the like. A computing system may have multi-tiered storage, for example having a combination of rotational drive storage and SSD storage. The various storage tiers may be grouped into one or more storage classes. Each storage class may have a characteristic performance and capacity. For example, an SSD tier may provide fast response for random and serial I/O but with less storage capacity due to their cost, while a rotational drive tier may provide adequate performance for sequential access but lesser performance with respect to random I/O access. However, rotational drives may have higher storage capacity due to their lower cost.

In some embodiments, a number of storage classes may be defined, each of which have a characteristic performance and capacity that may be implemented using a storage tier or a combination of storage tiers. In some embodiments, a storage class with faster I/O performance may be referred to as a performance class, and may be implemented primarily with faster response storage tiers such as SSD. In one embodiment, a storage class with higher storage capacity but with slower random access speeds may be referred to as a capacity class, and may be implemented primarily with high capacity tiers such as a rotational drive.

In some embodiments, a storage class may be implemented, which in this disclosure may be implemented as one or more tiers which each represent a particular storage device or storage device type. A storage class may be defined, for example, as providing a specified read access speed or a minimum and maximum read access speed, and may be implemented with one or more storage tiers that provide the specified parameters. The storage class may, for example, be a performance class or a capacity class. The specific storage tier may not be specifically called out or available for selection. The underlying storage tiers and their abstraction within a storage class may be changed by the system to deliver the requested class attributes. For example, the performance class may be implemented using a combination of storage-class memory (SCM) and SSD. Other classes may be implemented, such as a class that has higher performance than the capacity class and with higher capacity but with lesser performance than the performance class. Accordingly, more than two classes may be implemented. However, for the purposes of illustration, the present disclosure will describe two classes in many examples.

The use of classes and tiers may provide improvements over other methods such as using a cache to locally store data. While a cache may be used to provide quick access to frequently used data, use of a cache typically requires pre-fetching of data based on heuristics. Furthermore, the cache is a copy of the stored data, thus requiring maintaining and synchronizing two copies of the data. Finally, pre-fetching requires anticipation of what data should be loaded via heuristics or other measurements that are indicative of data likely to be requested by a user. However, when other data is requested that is not available in the cache, then the data must be retrieved from storage which may result in a performance hit.

The present disclosure provides a way to more predictably obtain efficient I/O performance when using a tiered storage system by pinning components that are known to be consistently and deterministically accessed by known processes. As used herein, pinning, may refer to any process that causes a particular storable component to be stored in a designated storage tier or class. For example, pinning may refer to indicating, for a given component, a class or tier of a multi-tiered storage system. Pinning may be implemented via a setting in metadata associated with the component, via settings in a file allocation table, or any other means for associating the desired pinning with a component. In an embodiment, when a component is pinned to a class, one or more memory blocks in the physical address space of a tier in the pinned class may be allocated for the component. In one embodiment, a rule or policy may be implemented that defines storage classes and how storage tiers should be allocated given a specified storage class. For example, a rule may state that a component pinned to a performance class should first be allocated to a first storage tier of the performance class, and if space is not available, then to a second storage tier of the performance class.

In some embodiments, a content item, which may also be referred to herein as a component, may be pinned to a particular tier of a storage class with one or more characteristics, such as an SSD or rotational disk. In other embodiments, a content item may be pinned to a storage class, which may be a set of capabilities that may in turn be implemented using a single storage tier or a combination of tiers that meet the set of capabilities. A component may refer to any data that can be loaded to a physical storage location, such as data files, executables, DLLs, drivers, hives, event log files, scripts, and the like. A component may also be a subset of a greater whole, such as a subfile that can be allocated to one or more physical addresses.

The efficiencies of consistently providing the fastest data access to what is deterministically known to be accessed, or has a specified likelihood of being accessed, can allow for improved efficiency and performance when executing boot and other processes that require access to stored data.

When a combination of storage classes is provided as a virtualized volume, a common address space may be implemented, while the underlying allocation of components to specific memory blocks may be assigned to any of the tiers within a specified storage class.

A determination as to which of the tiers or classes to pin a particular component may be based on a deterministic assessment of the demand for a component. For example, during a boot sequence, the directories and system files that are known to be accessed based on historical data may be identified as candidates for pinning to a particular tier or class.

In one example, a computing system may have a set of components that may be used for system launch such as system binaries and drivers that are determined to be consistently accessed by the boot loader as part of the boot process. For such folders and files that are consistently accessed on the boot path, it would be advantageous to pin these folders and files to a performance class in order to have the components loaded with a quick response time. Additionally, other directories and files that are deterministically identified as being consistently accessed may be pinned to the performance class to ensure good boot performance.

An additional advantage of using a pinning mechanism is that some files or directories may have portions of the files or directories that can benefit from being allocated to one tier or class, but other portions of the files or directories that do not require the same type of tier or class. For example, some portions of the files or directories may be identified as requiring a performance class, and other portions may be identified as only requiring a capacity class. In some embodiments, portions of files, or subfiles, may be allocated to different tiers or classes. In some embodiments, an allocation mechanism may be provided that allows specific files or portions of files to be pinned or allocated to a selected class. For example, some parts of a file may have different usage profiles, as some parts may have high usage and other parts may be rarely accessed. In one embodiment, cluster-level granularity may be provided for pinning to tiers or classes. For example, a range of clusters may be pinned to a designated class or tier, where the range may be a subset of a file or other component.

The decision as to which components are to be pinned to each tier or class may be determined by the OEM or other entity based on known and deterministic information, such as information regarding an operating system. In some embodiments, the pinning, once established, may not be modifiable. An operating system typically has many files, executables, DLLs, drivers, hives, event log files, scripts, data files, settings, and the like. It may be determined that a subset of these components, such as the executables, DLLs, and drivers, are consistently and frequently accessed and therefore would benefit from being pinned to the performance class. This determination may be based on actual observed data that demonstrate a known usage profile for the components. For example, boot profiles may be deterministic for a given set of computing resources. The system provider may analyze boot profiles and monitor data for which components are accessed over time. Based on analysis of the profiles over a number of boot cycles, a determination can be made regarding which components are most frequently accessed, or some other desired profile. Based on this analysis, various components can be pinned to the performance class, for example. By selecting components that are known to be accessed in a deterministic and predictable manner, the speed and efficiency of various functions such as launching an operating system and launching applications can be improved.

In some embodiments, when a component is pinned, the metadata for the component may be updated to include the designated tier or class. When storage allocations are determined, the pinned tier or class for the component may be read from metadata, and a location may be allocated in the desired tier or class. In some cases, if there is no more space available in the desired tier or class, then the next available tier may be assigned. In some embodiments, a flag may be provided for each component, indicating whether the desired tier or class is mandatory or if a best effort may be implemented. If the desired tier or class is mandatory, then if the desired tier or class is not available, then an error may be logged. For example, the file may be created but an allocation error may be logged, or a prompt may be provided for user intervention.

In some embodiments, directories can be pinned to a tier or class. Additionally, in some embodiments the file may inherit the pin designation of the directory that it is associated with. For example, if a directory is pinned to a tier or class, then a file that is created in that directory may inherit the tier or class of the parent directory.

In an embodiment, if a file is created and pinned to the capacity class, and if the file is then moved to the performance class, the file may maintain the pin to the capacity class. However, if the file is copied (renamed) in the performance class, then the copy may inherit the pin to the performance class. In some embodiments, where multiple file names point to the same file, inheritance may be provided based on the most recent target directory (e.g., the last designation prevails).

In some embodiments, inheritance or persistence of a pin designation may be enabled for multiple files or levels of files where a directory is moved, assigned, or copied to a class. In other words, when a directory is moved from one area to another where the destination changes the class, then the files within the directory may persist their current pinning attributes. However, if a directory is copied to an area that changes the class of the original copy, then the copied directory may inherit the pin designation of the new location. An override may be provided so that inheritance is not attributed to subfolders in certain cases, such as when the directory structure is large and the time to extend the attributes to all subfolders and their contents would be excessive or if there is insufficient capacity.

Additionally, in some embodiments each file may be assigned a default pinning if one is not explicitly assigned. For example, each file may be assigned a default pin to the capacity class.

In some embodiments, a file system may operate on an underlying volume that has multiple classes, each class including a particular set of features or characteristics. When creating a file system namespace (such as a directory or file), or otherwise identifying a file system namespace within a volume, a storage set of features or characteristics set to be associated with the file system namespace is identified. The file system namespace may then be caused to be stored within the identified class in the volume. Thus, the file system is provided with a volume that has multiple classes (each having different sets of features or characteristics) to choose from in storing files.

In the description that follows, embodiments are described with reference to operations that are performed by one or more computing systems. If such operations are implemented in software, one or more processors of the associated computing system that performs the operations may direct the operation of the computing system in response to having executed computer-executable instructions. For example, such computer-executable instructions may be embodied on one or more computer-readable media that form a computer program product. An example of such an operation involves the manipulation of data. The computer-executable instructions (and the manipulated data) may be stored in the memory of the computing system.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media.

Computer storage media includes RAM, ROM, EEPROM, CD-ROM or other optical disk storage, magnetic disk storage or other magnetic storage devices, or any other tangible medium which can be used to store desired program code means in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

In a computing environment, a volume system may use a volume exposure system to expose a volume to a file system. The computing environment may be, for example, implemented in the computing system.

The volume may include storage represented in the form of contiguous logical addresses. In this description and in the claims, a “volume” is defined as any group of one or more logical address extents that is presented to a file system in the form of a single namespace. When the file system issues a read or write request to the volume system, the file system request may include a logical address. The volume system is configured to recognize the part of the volume that is being addressed using the logical address provided by the file system. Thus, from the file system point of view, the file system has access to the entire volume logically addressable throughout the entire extent of the volume.

Because not all storage locations in the volume have the same sets of features or characteristics, the volume may be viewed as a heterogenic volume, being composed of portions that have different sets of features or characteristics. A mapping system may map each of at least some of the logical storage locations of the volume to a corresponding physical storage location in underlying storage systems.

The term “physical” storage location or “physical” address may reference a storage location or address, respectively, in the underlying storage systems, thus distinguishing the addressing scheme (i.e., “logical addressing scheme”) used by the file system when addressing the heterogenic volume from the addressing scheme (i.e., “physical addressing scheme”) used by the underlying storage system to access storage offered by the corresponding underlying storage system. For instance, the file system may use “logical” addresses to address the storage within the volume. However, the storage systems may use “physical” addresses to access the respective storage locations.

In some embodiments, there may be one or more further levels of mapping abstraction that separate even the underlying storage system from the actual physical storage medium. For example, the underlying storage system might be physical storage systems such as flash memory, solid-state disks, mechanical disks and so forth. However, the storage system might also comprise some type of consolidated storage system that offers up addresses that are mapped to further underlying storage systems. Furthermore, there may be one or more transformations (such as encryption or compression) that the storage system applies to the data prior to storing to a given storage location, and one or more reverse transformations (such as decryption or decompression) that the storage system applies to the data after reading data from the given storage location.

In some embodiments, granularity of storage locations may be represented by a basic unit that the mapping system works with in order to map storage locations. Each unit may represent contiguous address locations (e.g., contiguous logical blocks) in the logical addressing scheme recognized by the file system. In order to simplify the mapping, each unit may also represent contiguous address locations in the physical addressing scheme.

Smaller units may have the advantage of having more fine-grained control over the boundaries between storage of different sets of features or characteristics in the volume, but have the disadvantage of increasing the number of mappings that the mapping system keeps track of.

In some embodiments, a tier may be defined as a set of one or more regions having a common set of features or characteristics.

The file system may include metadata about the volume such as the size of the volume, and the size and logical storage location(s) of each of the classes. The metadata might also include the sets of features or characteristics of each of the classes. The metadata may, for example, be persisted. The file system may use this metadata to make decisions regarding where to place a file system namespace (such as a directory or file), or a portion thereof, into the volume. There may be different types of metadata, e.g. system metadata and user metadata. System metadata refers to information kept by the file system to facilitate basic operations, including data allocation, ensuring system integrity, etc. User metadata refers to metadata that tracks file names, directory structures, and other user generated information

One example of a feature or characteristic may be an actual tier or type of underlying storage system. For instance, the type or tier might specify flash memory, disk device, cloud storage, or any other type of storage system. The type or tier might also specify broader categories such as solid state storage that involves no mechanically interacting pieces, or mechanism storage that has one or more mechanically interacting pieces.

A storage class may have a performant characteristic which relates to the performance of the storage. For instance, a read/write performant characteristic relates to the performance of the storage when performing read/write operations. For instance, read/write performant classes might be a function of latency (read and/or write), data transfer speed (read and/or write), or the like.

A storage class may also specify a resiliency characteristic that relates to a level of redundancy built into the storage class. For instance, some storage might be 3-way mirrored, which is offered to survive failure of a single physical storage device. Some storage might have higher levels of redundancy surviving failure of more than one physical device, and the resiliency trait might specify a minimum level of redundancy.

A characteristic set for a given storage class may include any one or more of these enumerated characteristics or additional characteristics not enumerated, or combinations thereof.

A file system typically controls how data is stored and retrieved from a storage device. For example, a file system may enable data to be stored in files, which are located in a directory structure. The file system tracks files and directories with metadata, which is also stored on the underlying storage device. Other types of metadata ensure integrity of the file system in the event of an unexpected error, provide for recovery of lost data, improve performance by enabling optimizations, and the like.

The space capacity for the types of storage may vary depending on the type of device (tablet, smartphone), type of system (64 bit or 32 bit), operating system version, the size of the device's storage space, etc.

In some embodiments, spillover from one storage tier or class to another may be allowed. Whether spillover is allowed may be determined based on the storage class. For example, the performance class may be characterized in that there is no spillover allowed into this area.

The capacity storage class may be characterized in that data that is pinned to the performance storage class may be allowed to spillover to the capacity storage class. In this case, even if an allocation to the performance storage class requires more space than the amount available in the performance storage class, the allocation may be successful if the capacity storage class has sufficient space to take the spillover.

Requests for pinning a component to a class or tier may be generated by a process executing in the OS or from an authorized user via the API. In one embodiment, the ability to pin to a class or tier may only be available to the operating system of the computing device, for example via the file system. In some embodiments, applications and other users may make requests for pinning specified components to a specified class or tier. The operating system may grant or deny requests based on whether the request pertains to a performance class or a capacity class, and based on current status or available space.

In some embodiments, when requests for pinning to a class or tier are in conflict, then the OS can prioritize the requests based on a predetermined priority, the current available space, and other factors.

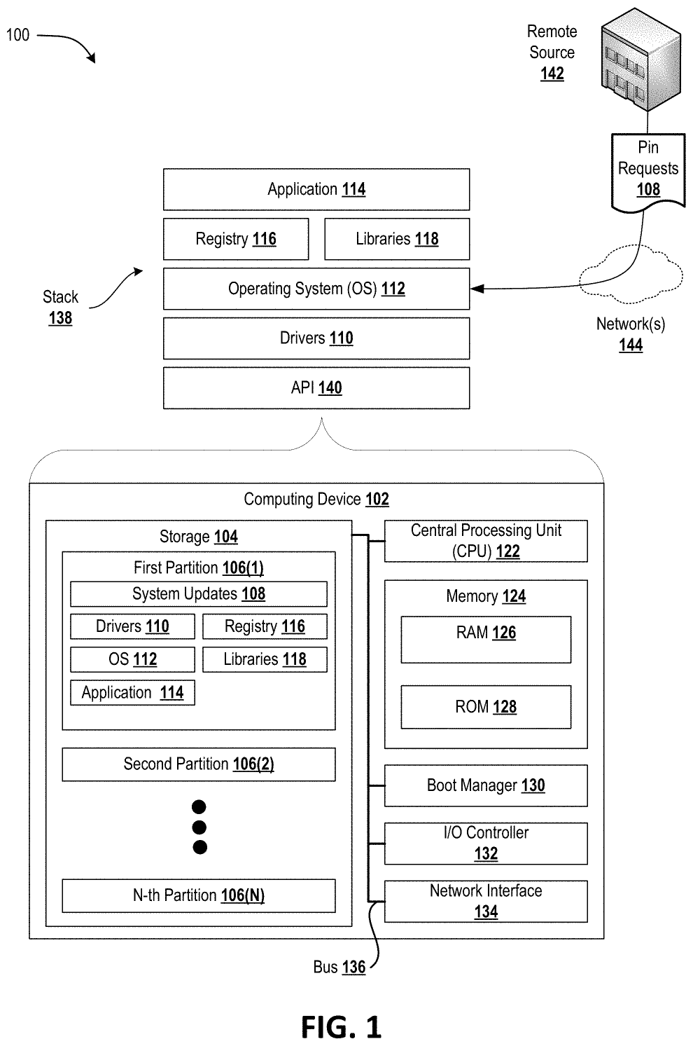

Turning now to FIG. 1, illustrated is an example computing architecture 100 that receives pinning requests 108 on a computing device 102. The computing device 102 is configured to pin content items to accommodate the pinning requests 108. For example, updates may be received to update one or more system components. Example system components include, but are not limited to, drivers 110, an operating system (OS) 112, an application 114, a registry 116, and/or libraries 118.

As illustrated in FIG. 1, the computing device 102 may include one or more drive(s) 104 (hereinafter referred to as the “drive”) having computer-readable media that provides nonvolatile storage for the computing device 102. Example drives include, but are not limited to, SATA-type solid-state hard drives, SATA-type hard disks, PATA-type solid-state hard drives, PATA-type hard disks, and/or any other drive-type suitable for providing non-volatile computer-readable media to a computing device. The storage 104 may include partitions 106 for logically separating one or more system components and/or data objects. In the illustrated example, the storage 104 is separated into a first partition 106(1), a second partition 106(2), and an N-th partition 106(N). In some embodiments, at least one of the partitions 106 stores drivers 110 and an operating system (OS) 112 to enable a boot manager 130 to initiate the drivers 110 and to load the OS 112 into a memory 124. In the illustrated example, the memory 124 includes a random-access memory (“RAM”) 126 and a read-only memory (“ROM”) 128. As further illustrated, the computing device 102 includes a central processing unit (“CPU”) 122 that is connected, via a bus 136, to the storage 104, the memory 124, and the boot manager 130. In some embodiments, the bus 136 further connects an input/output (I/O) controller 132 and/or a network interface 134.

It can be appreciated that the system components described herein (e.g., the drivers 110, the OS 112, and/or the application 114) may, when loaded into the CPU 122 and executed, transform the CPU 122 and the overall computing device 102 from a general-purpose computing system into a special-purpose computing system customized to facilitate the functionality presented herein. The CPU 122 may be constructed from any number of transistors or other discrete circuit elements, which may individually or collectively assume any number of states. More specifically, the CPU 122 may operate as a finite-state machine, in response to executable instructions contained within the software modules disclosed herein. These computer-executable instructions may transform the CPU 122 by specifying how the CPU 122 transitions between states, thereby transforming the transistors or other discrete hardware elements constituting the CPU 122.

The storage 104 and associated computer-readable media provide non-volatile storage for the computing device 102. Although the description of computer-readable media contained herein refers to one or more storage devices, such as a solid-state drive and/or a hard disk, it should be appreciated by those skilled in the art that computer-readable media can be any available computer storage media or communication media that can be accessed by a computing architecture such as, for example, the computing architecture 100. Communication media includes computer-readable instructions, data structures, program modules, and/or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above are also included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, SSD, SCM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing device 102. For purposes of the claims, the phrase “computer storage medium,” “computer-readable storage medium,” and variations thereof, does not include waves, signals, and/or other transitory and/or intangible communication media, per se.

The boot manager 130 may access the OS 112 from the storage 104 (or a partition thereof) and may load the OS 112 into the memory 124 for runtime execution by the computing device 102 (e.g., by invoking an OS boot loader). The I/O controller 132 may receive and process input from a number of other devices, including a keyboard, mouse, or electronic stylus (not shown in FIG. 1). Similarly, the I/O controller 132 may provide output to a display screen, a printer, or other type of output device (also not shown in FIG. 1). The network interface 134 may enable the computing device 102 to connect to one or more network(s) 144 such as a local area network (LAN), a wide area network (WAN), a wireless local area network (WLAN), or any other suitable network for passing information between the computing device 102 and a remote resource 142.

As described above, the storage 104 may include multiple partitions 106 for logically separating one or more system components and/or data objects. In the illustrated example, the storage 104 includes the first partition 106(1) which stores instances of the drivers 110, the OS 112, the application 114, the registry 116, and the libraries 118. The drivers 110 may include one or more programs for controlling one or more devices that are communicatively coupled to the computing device 102 such as, for example, printers, displays, cameras, soundcards, network cards, computer storage devices, etc. The OS 112 may be any suitable system software for managing computer hardware and/or software resources and for providing services to the application 114 and/or other applications (not shown). An example OS 112 may include, but is not limited to, various versions of MICROSOFT WINDOWS (e.g., WINDOWS 8.1 or 10, WINDOWS EMBEDDED STANDARD 7, etc.), Mac OS X, iOS, etc.

The application 114 may be a computer program that is configured to be run by the OS 112 to perform one or more coordinated functions, tasks, activities. The registry 116 may correspond to a database containing information usable to boot and/or configure the OS 112, system-wide software settings that control the operation of the OS 112, security databases, and/or user specific configuration settings. The registry 116 may further contain information associated with in-memory volatile data such as, for example, a current hardware state of the OS 112 (e.g., which drivers are currently loaded and in use by the OS 112).

The libraries 118 may include a collection of non-volatile resources that are usable (e.g., callable) by the application 114 and/or other applications (not shown). Example resources include, but are not limited to, pre-written code and/or subroutines, configuration data, and/or classes (e.g., extensible program-code-templates for creating objects of various types). In various implementations, the libraries 118 may enable the application 114 to call upon various system services provided by the OS 112. For example, the libraries 118 may include one or more subsystem Dynamic Link Libraries (DLLs) configured for implementing and/or exposing Application Programming Interface (API) functionalities of the OS 112 to the application 114.

In one embodiment, APIs 140 may be implemented for receiving pinning requests and managing the requests. In an embodiment, at least one API may be configured to query information about one or more storage tiers or classes. Returned information may include current state information such as the amount of space used.

In an embodiment, at least one API may be configured to send a request to the file system to calculate the space used against one or more storage tiers or classes on a volume, by locating all files and directories pinned to a particular tier or class and adding up their total allocation. The API may be configured to enumerate all files and directories on a volume that are pinned to a specified tier or class. In some embodiments, if a requested tier or class for a component is not received, then when an allocation request is made for the component, other ways to determine a storage class or tier may be used. For example, a default storage class or tier may be assigned. If the allocation request is for a component that is being moved or copied, or created within a directory that is already pinned, then a rule or policy may be used to determine the storage class or tier. The rule or policy for the determining which storage class or tier to assign a moved or copied component, or a component created within an existing directory may implement inheritance as discussed elsewhere in this disclosure.

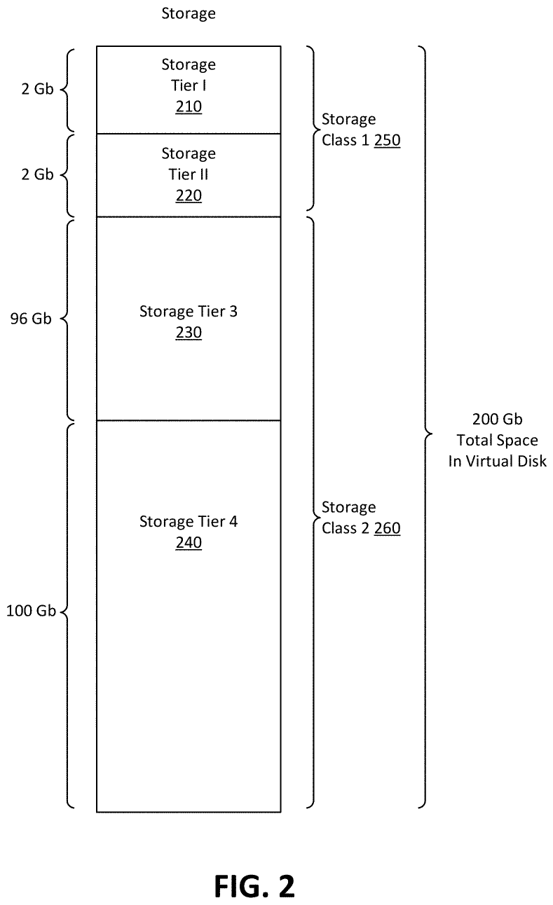

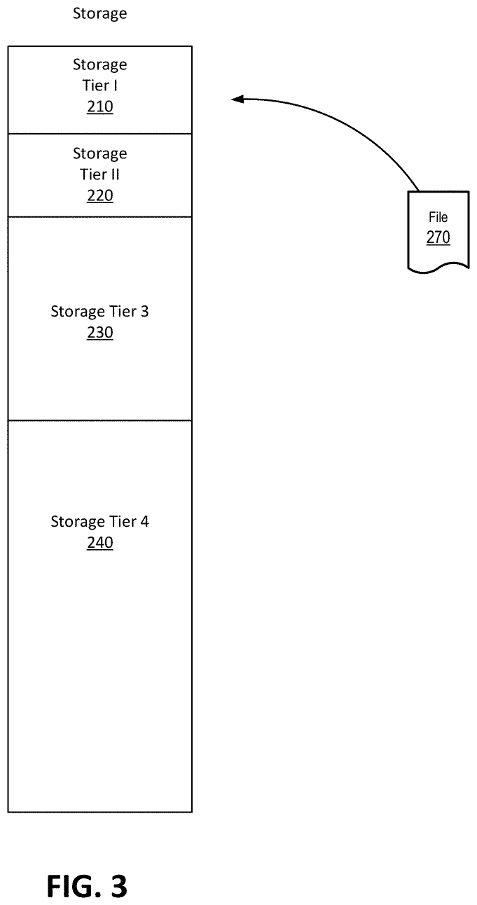

FIG. 2 illustrates different types of storage tiers and classes. Storage class 1 250 illustrates a first storage class that may provide a first set of features or characteristics. Storage class 2 260 illustrates a second storage class that may provide a second set of features or characteristics. Storage class 1 250 may comprise storage tier 1 210 and storage tier 2 220. Storage class 2 260 may comprise storage tier 3 230 and storage tier 4 240. The two storage classes may collectively be presented as a virtual disk with a total storage capacity. Referring to FIG. 3, a file 270 may initially be pinned to storage tier 210 with the first storage class 250. Metadata for file 270 may be updated to indicated that file 270 is pinned to the first storage class. An allocation may be made for file 270 in an address range that is implemented in storage tier 1 210 or storage tier 2 220. The specific storage tier may be determined based on a rule or policy.

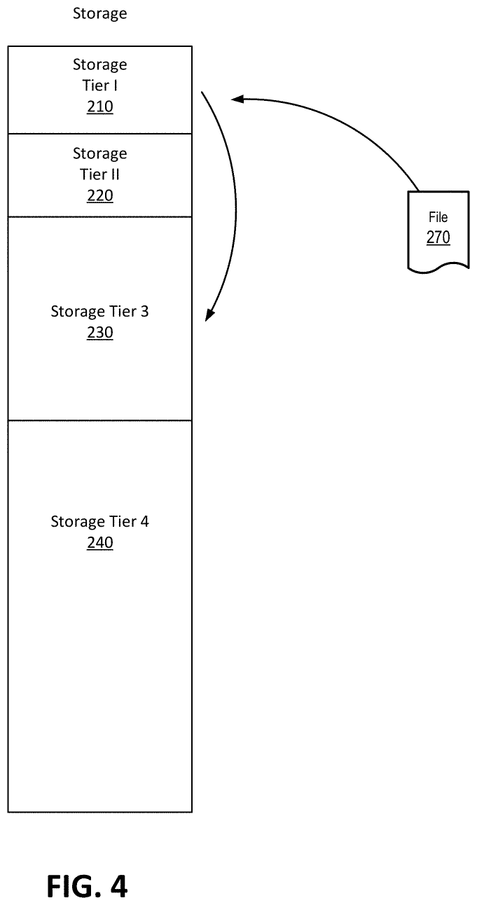

In an embodiment, under various conditions, files and directories may automatically inherit the storage class or tier of their parent. As illustrated in FIG. 4, file 270 that is pinned to storage tier type 1 210 and is later moved to a directory in storage tier type 3 230 may maintain its pinning to storage tier type 1 210. If file 270 is copied to a new parent in storage tier type 3 230, then file 270 may automatically inherit storage tier type 3 230.

When a non-empty directory is moved to a new parent, in some embodiments, if the new storage tier or class is different, the class or tier of contents in the directory may remain the same. When a non-empty directory is copied to a new parent, in addition to inheritance on the directory being moved, in some embodiments, if the new storage tier or class is different, the class or tier of contents in the directory may change to the storage tier or class of the new parent. Copies may therefore take an unexpectedly long time. To provide for cases where copy inheritance is not desired, an opt-out flag may be provided.

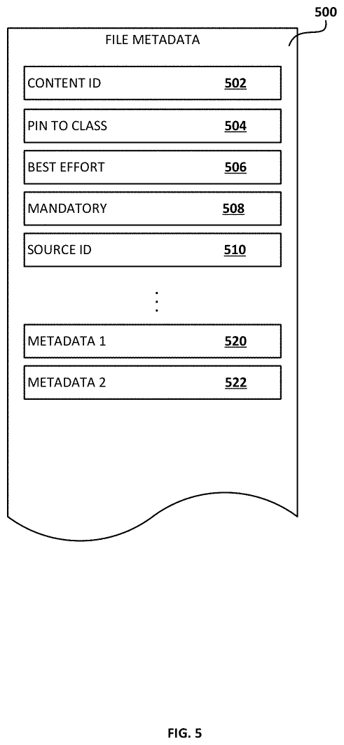

FIG. 5 is a data structure diagram showing a number of data elements stored in a metadata record 500 storing metadata for storage allocation in conjunction with a tiered storage with at least two types of storage classes. It will be appreciated by one skilled in the art that the data structure shown in the figure may represent a data file, a database table, an object stored in a computer storage, a programmatic structure or any other data container commonly known in the art. Each data element included in the data structure may represent one or more fields in a data file, one or more columns of a database table, one or more attributes of an object, one or more variables of a programmatic structure or any other unit of data of a data structure commonly known in the art.

Each reservation record 500 may contain a content ID 502 identifying the particular content item for which a pinning request is to be stored. According to one embodiment, reservation record 500 may also contain a pin to class indication 504 identifying the class with which the content item is to be associated with. In one example, the pin to class indication 504 may indicate, for example, a performance class or a capacity class. The reservation record 500 may also contain a best effort field 506 indicating, for example, if the pinning request may be replaced with a best available tier if the requested tier is not available.

The reservation record 500 may also contain information regarding a mandatory field 508 which indicates whether the requested class is mandatory. The reservation record 500 may contain a source ID field 510 indicating, for example, the source of the request, which can indicate the operating system, OEM, application, and the like. The reservation record 500 may further contain information regarding one or more metadata 520 and 522. It will be appreciated that the reservation record 500 may contain additional data elements beyond those shown in FIG. 5 and described above that are utilized in conjunction with reserve storage areas.

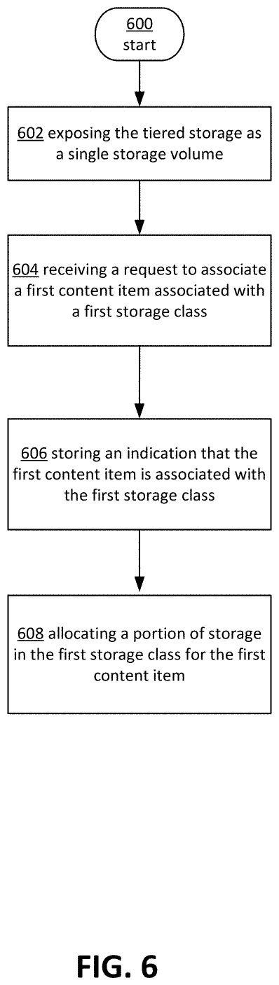

Turning now to FIG. 6, illustrated is an example operational procedure for storage allocation in a computing device communicatively coupled to a tiered storage with at least two types of storage classes, the storage classes comprising one or more storage tiers, in accordance with the present disclosure. In an embodiment, the example operational procedure may implement a method executing on one or more computing devices. Such an operational procedure may provide for implementing a storage reserve as described herein and as illustrated in FIGS. 1-5.

Referring to FIG. 6, operation 602 illustrates exposing the tiered storage as a single storage volume. Operation 602 may be followed by operation 604. Operation 604 illustrates receiving a request to associate a first content item with a first storage class.

Operation 604 may be followed by operation 606. Operation 606 illustrates storing an indication that the first content item is associated with the first storage class. In an embodiment, the indication may be received via an application programming interface (API).

Operation 606 may be followed by operation 608. Operation 608 illustrates allocating a portion of storage in the first storage class for the first content item.

In an embodiment, the first content item may be stored in the allocated portion of storage in the first storage class. Additionally and optionally, the first content item may be stored in a second storage class when capacity in the first storage class is insufficient.

In an embodiment, a file system namespace may be implemented that abstracts the at least two types of storage classes. In some embodiments, a further indication may be received that pinning to the indicated first storage class is mandatory. An error may be generated when capacity in the first storage class is insufficient

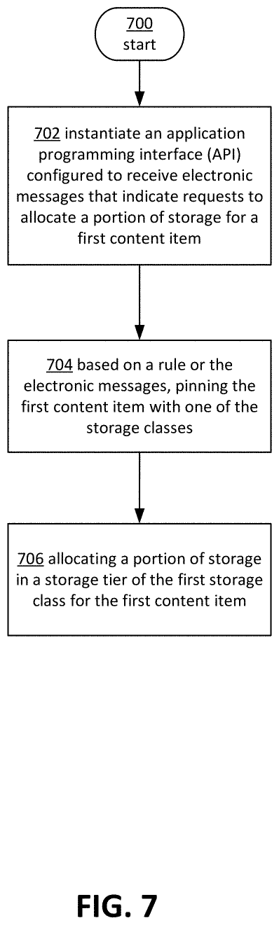

Turning now to FIG. 7, illustrated is an example operational procedure for storage allocation in a computing device communicatively coupled to a tiered storage with at least two types of storage classes in accordance with the present disclosure. Operation 702 illustrates instantiating an application programming interface (API) configured to receive electronic messages that indicate requests for a first content item to be pinned to a storage class. Operation 702 may be followed by operation 704. Operation 704 illustrates in response to one of the requests, reserving a first portion of a total capacity of the storage of the computing device for system update tasks.

Operation 704 may be followed by operation 706. Operation 706 illustrates allocating a portion of storage in the first storage class for the first content item.

In an embodiment, the first content item may be a subfile. Additionally and optionally, storage for the subfile is allocated as a range of storage blocks.

In an embodiment, the pinning comprises updating metadata associated with the first content item to indicate that the first content item is pinned to the first storage class. In some embodiments, the pinning comprises updating a flag associated with the first content item to indicate that the requested storage class is mandatory.

In an embodiment, when the first content item is moved to directory associated with a second storage class, the first content item remains pinned to the first storage class. Additionally and optionally, when the first content item is copied to directory associated with a second storage class, the copy of the first content item is pinned to the second storage class.

In an embodiment, content items may be pinned with a default storage class for content items for which a pinning request has not been received.

In an embodiment, the first content item may be one or more of data files, executables, DLLs, drivers, hives, event log files, scripts, or settings that are usable for a boot process of the computing device.

In an embodiment, the first storage class may be a performance class and a second storage class may be a capacity class.

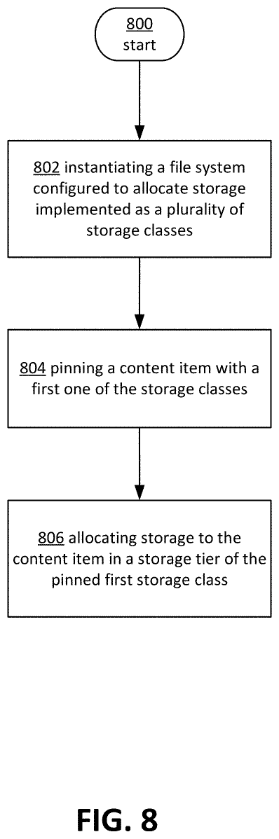

Turning now to FIG. 8, illustrated is an example operational procedure for storage allocation in a computing device communicatively coupled to a tiered storage with at least two types of storage classes in accordance with the present disclosure. Operation 802 illustrates instantiating a file system configured to allocate storage implemented as a plurality of storage classes. In an embodiment, the storage classes each corresponding to a set of performance and capacity characteristics. Operation 802 may be followed by operation 804. Operation 804 illustrates pinning a content item with a first one of the storage classes.

Operation 804 may be followed by operation 806. Operation 806 illustrates allocating storage to the content item in accordance with the pinned first storage class. In an embodiment, the storage may be allocated to the content item with cluster-level granularity. In some embodiments, the content item may comprise a subfile.

In an embodiment, a selected set of content items may be pinned that are loaded as part of a boot process.

Each of the processes, methods and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel or in some other manner. Blocks or states may be added to or removed from the disclosed example embodiments. The example systems and components described herein may be configured differently than described. For example, elements may be added to, removed from or rearranged compared to the disclosed example embodiments.

It will also be appreciated that various items are illustrated as being stored in memory or on storage while being used, and that these items or portions of thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (ASICs), standard integrated circuits, controllers (e.g., by executing appropriate instructions, and including microcontrollers and/or embedded controllers), field-programmable gate arrays (FPGAs), complex programmable logic devices (CPLDs), etc. Accordingly, the present invention may be practiced with other computer system configurations.

Conditional language used herein, such as, among others, “can,” “could,” “might,” “may,” “e.g.” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some or all of the elements in the list.

While certain example embodiments have been described, these embodiments have been presented by way of example only, and are not intended to limit the scope of the inventions disclosed herein. Thus, nothing in the foregoing description is intended to imply that any particular feature, characteristic, step, module or block is necessary or indispensable. Indeed, the novel methods and systems described herein may be embodied in a variety of other forms; furthermore, various omissions, substitutions and changes in the form of the methods and systems described herein may be made without departing from the spirit of the inventions disclosed herein. The accompanying claims and their equivalents are intended to cover such forms or modifications as would fall within the scope and spirit of certain of the inventions disclosed herein.

### EXAMPLE CLAUSES

The disclosure presented herein may be considered in view of the following clauses.

Example Clause A, a method for storage allocation in a computing device communicatively coupled to a tiered storage with at least two types of storage classes, the storage classes comprising one or more storage tiers, the method comprising: exposing the tiered storage as a single storage volume;
receiving a request to associate a first content item with a first storage class;
storing an indication that the first content item is associated with the first storage class; and
allocating a portion of storage in a storage tier of the first storage class for the first content item.

Example Clause B, the method of Example Clause A, further comprising storing the first content item in the allocated portion of storage tier in the first storage class.

Example Clause C, the method of any of Example Clauses A through B, further comprising storing the first content item in a storage tier of a second storage class when capacity in the first storage class is insufficient.

Example Clause D, the method of any of Example Clauses A through C, further comprising implementing a file system namespace that abstracts the at least two types of storage classes.

Example Clause E, the method of any of Example Clauses A through D, wherein the indication is received via an application programming interface (API).

Example Clause F, the method of any of Example Clauses A through E, further comprising receiving a further indication that pinning to the indicated first storage class is mandatory, wherein an error is generated when capacity in the first storage class is insufficient.

Example Clause G, a computing device comprising:

one or more processors; and

one or more storage devices in communication with the one or more processors, the storage devices configured with tiered storage with at least two types of storage classes, the storage classes comprising one or more storage tiers, the one or more storage devices further storing thereon computer-readable instructions stored thereupon which, when executed by the one or more processors, cause the computing device to:

instantiate an application programming interface (API) configured to receive electronic messages that indicate requests to allocate a portion of storage for a first content item;

based on a rule or the electronic messages, pinning the first content item with one of the storage classes; and

allocating a portion of storage in a storage tier of the first storage class for the first content item.

Example Clause H, the computing device of Example Clause G, wherein the first content item is a subfile.

Example Clause I, the computing device of any of Example Clauses G through H, wherein storage for the subfile is allocated as a range of storage blocks.

Example Clause J, the computing device of any of Example Clauses G through I, wherein the pinning comprises updating metadata associated with the first content item to indicate that the first content item is pinned to the first storage class.

Example Clause K, the computing device of any of Example Clauses G through J, wherein the pinning comprises updating a flag associated with the first content item to indicate a request for a storage class, and that the request storage class is mandatory.

Example Clause L, the computing device of any of Example Clauses G through K, wherein when the first content item is moved to directory associated with a second storage class, the first content item remains pinned to the first storage class.

Example Clause M, the computing device of any of Example Clauses G through L, wherein when the first content item is copied to directory associated with a second storage class, the copy of the first content item is pinned to the second storage class.

Example Clause N, the computing device of any of Example Clauses G through M, further comprising pinning content items with a default storage class for content items for which a pinning request has not been received.

Example Clause O, the computing device of any of Example Clauses G through N, wherein the first content item is one or more of data files, executables, DLLs, drivers, hives, event log files, scripts, or settings that are usable for a boot process of the computing device.

Example Clause P, the computing device of any of Example Clauses G through O, wherein the first storage class is a performance class and a second storage class is a capacity class.

Example Clause Q, a method comprising:

instantiating a file system configured to allocate storage implemented as a plurality of storage classes, the storage classes each corresponding to a set of storage tiers having performance and capacity characteristics;

pinning a content item with a first one of the storage classes; and

allocating storage to the content item in a storage tier of the pinned first storage class.

Example Clause R, the method of Example Clause Q, wherein the storage is allocated to the content item with cluster-level granularity.

Example Clause S, the method of any of Example Clauses Q through R, wherein the content item comprises a subfile.

Example Clause T, the method of any of Example Clauses Q through S, further comprising pinning a selected set of content items that are loaded as part of a boot process.

While Example Clauses G through P are described above with respect to a computing device, it is also understood in the context of this disclosure that the subject matter of Example Clauses G through P can additionally and/or alternatively be implemented via a method, a system, and/or computer storage media.

1. A method for storage allocation in a computing device communicatively coupled to a tiered storage with at least two types of storage classes, the storage classes comprising one or more storage tiers, the method comprising:
exposing the tiered storage as a single storage volume;
receiving a request to associate a first content item with a first storage class;
storing an indication that the first content item is associated with the first storage class; and
allocating a portion of storage in a storage tier of the first storage class for the first content item.

2. The method of claim 1, further comprising storing the first content item in the allocated portion of storage tier in the first storage class.

3. The method of claim 1, further comprising storing the first content item in a storage tier of a second storage class when capacity in the first storage class is insufficient.

4. The method of claim 1, further comprising implementing a file system namespace that abstracts the at least two types of storage classes.

5. The method of claim 1, wherein the indication is received via an application programming interface (API).

6. The method of claim 1, further comprising receiving a further indication that pinning to the indicated first storage class is mandatory, wherein an error is generated when capacity in the first storage class is insufficient.

7. A computing device comprising:
one or more processors; and
one or more storage devices in communication with the one or more processors, the storage devices configured with tiered storage with at least two types of storage classes, the storage classes comprising one or more storage tiers, the one or more storage devices further storing thereon computer-readable instructions stored thereupon which, when executed by the one or more processors, cause the computing device to:
instantiate an application programming interface (API) configured to receive electronic messages that indicate requests to allocate a portion of storage for a first content item;
based on a rule or the electronic messages, pinning the first content item with one of the storage classes; and
allocating a portion of storage in a storage tier of the first storage class for the first content item.

8. The computing device of claim 7, wherein the first content item is a subfile.

9. The computing device of claim 8, wherein storage for the subfile is allocated as a range of storage blocks.

10. The computing device of claim 7, wherein the pinning comprises updating metadata associated with the first content item to indicate that the first content item is pinned to the first storage class.

11. The computing device of claim 7, wherein the pinning comprises updating a flag associated with the first content item to indicate a request for a storage class, and that the request storage class is mandatory.

12. The computing device of claim 7, wherein when the first content item is moved to directory associated with a second storage class, the first content item remains pinned to the first storage class.

13. The computing device of claim 7, wherein when the first content item is copied to directory associated with a second storage class, the copy of the first content item is pinned to the second storage class.

14. The computing device of claim 7, further comprising pinning content items with a default storage class for content items for which a pinning request has not been received.

15. The computing device of claim 7, wherein the first content item is one or more of data files, executables, DLLs, drivers, hives, event log files, scripts, or settings that are usable for a boot process of the computing device.

16. The computing device of claim 7, wherein the first storage class is a performance class and a second storage class is a capacity class.

17. A method comprising:
instantiating a file system configured to allocate storage implemented as a plurality of storage classes, the storage classes each corresponding to a set of storage tiers having performance and capacity characteristics;
pinning a content item with a first one of the storage classes; and
allocating storage to the content item in a storage tier of the pinned first storage class.

18. The method of claim 17, wherein the storage is allocated to the content item with cluster-level granularity.

19. The method of claim 17, wherein the content item comprises a subfile.

20. The method of claim 17, further comprising pinning a selected set of content items that are loaded as part of a boot process.
